(19) United States
(12) Patent Application Publication
(10) Pub. No.: US 2005/0079768 A1
(43) Pub. Date: Apr. 14, 2005

(54) Memory card connector for mounting on a printed circuit board

(76) Inventors: Yi-Tse Ho, Bai-ho Gian (TW); Katsutoshi Tojo, Yamato-shi (JP)

Correspondence Address: MOLEX INCORPORATED, 2222 WELLINGTON COURT, LISLE, IL, 60532, US

(21) Appl. No.: 10/953,236

(22) Filed: Sep. 29, 2004

(30) Foreign Application Priority Data
Oct. 14, 2003 (TW) 92218264

(51) Int. Cl. H01R 24/00

(52) U.S. Cl. 439/630

(57) ABSTRACT

A system is provided for mounting a memory card connector on top of a printed circuit board in an elevated position on top of at least a pair of pillars projecting upwardly from a support structure. A plurality of fasteners extend from the connector through the printed circuit board into fastening engagement with the support structure to hold the connector and board on top of the pillars. A support member is provided beneath the printed circuit board between the pair of pillars to prevent the board from bending or warping between the pillars.

### FIELD OF THE INVENTION

This invention generally relates to the art of electrical connectors and, particularly, to a memory card connector for mounting on a printed circuit board.

### BACKGROUND OF THE INVENTION

Memory cards are known in the art and contain intelligence in the form of a memory circuit or other electronic program. Some form of card reader reads the information or memory stored on the card. Such cards are used in many applications in today's electronic society, including video cameras, digital still cameras, smartphones, PDA's, music players, ATMs, cable television decoders, toys, games, PC adapters, multi-media cards and other electronic applications. Typically, a memory card includes a contact or terminal array for connection through a card connector to a card reader system and then to external equipment. The connector readily accommodates insertion and removal of the card to provide quick access to the information and program on the card. The card connector includes terminals for yieldingly engaging the contact array of the memory card.

The memory card connector often is mounted on a printed circuit board. The memory card, itself, writes or reads via the connector and can transmit between electrical appliances, such as a word processor, personal computer, personal data assistant or the like. The connector terminals typically have tail portions for connection to appropriate circuit traces on the printed circuit board. The tail portions may be connected to the circuit traces by surface mount technology, wherein the tail portions are soldered to the circuit traces. The tails portions may be inserted into through holes in the circuit board for connection, as by soldering, to circuit traces on the board and/or in the holes. In either process, the solder connections involve high temperatures in a reflow process. In other instances, the tail portions simply may be electrically connected to the circuit traces by pressure engagement. This often is accomplished by using screws or other fasteners which run through the connector housing to tightly clamp the housing to the printed circuit board. In all of these processes or systems, problems are encountered when the connections between the tail portions of the terminals and the circuit traces on the board become loosened or otherwise damaged, or the tail portions even become separated from the circuit traces. This results in incomplete connections and defective circuitry. The defective connections can be caused by the circuit board bending or warping, for instance.

The above problems are magnified when the memory card connector is mounted to a printed circuit board and this subassembly, in turn, is mounted in an elevated position on top of a support structure. For instance, pillars may project upwardly from the support structure, and the subassembly is mounted on top of the pillars. The circuit board has a tendency to bend or warp between the pillars, and the connections between the terminal tail portions and the circuit traces on the board often are damaged. This is particularly true when the tail portions are connected to the circuit traces by pressure engagement. The present invention is directed to solving this myriad of problems.

### SUMMARY OF THE INVENTION

An object, therefore, of the invention is to provide a new and improved system for mounting a memory card connector on top of a printed circuit board in an elevated position on top of at least a pair of pillars projecting upwardly from a support structure.

In the exemplary embodiment of the invention, the system includes a memory card connector mountable on top of an appropriate printed circuit board. Fastening means extend from the connector through the printed circuit board into fastening engagement with the support structure to hold the connector and board on top of the pillars. Support means are provided beneath the printed circuit board between the pair of pillars to prevent the board from bending or warping between the pillars.

According to one embodiment of the invention, the support means is provided by a separate rigid support bracket mounted to the underside of the printed circuit board. The support bracket is elongated and extends between the pair of pillars. The fastening means include a pair of fasteners extending through the connector, through the printed circuit board, through the elongated support bracket and into the pair of pillars. The printed circuit board includes a linear array of contact pads engageable by a linear array of tail portions of a plurality of terminals on the memory card connector. The linear array of contact pads and tail portions extend generally between the pair of pillars. The elongated support bracket is disposed beneath the circuit board in position to support the contact pads against the tail portions of the terminals.

In another embodiment of the invention, the support means comprises an elongated support rib extending between the pair of pillars above the support structure. Preferably, the elongated support rib is integral with the pair of pillars. Again, the fastening means include a pair of fasteners extending through the connector, through the printed circuit board and into the pair of pillars.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective view of a memory card connector, printed circuit board and support structure incorporating a first embodiment of the invention;

FIG. 2 is a bottom perspective view of the memory card connector assembled to the printed circuit board and including the support bracket of the first embodiment;

FIG. 3 is a view similar to that of FIG. 1, but of a second embodiment of the invention; and

FIG. 4 is a perspective view of the memory card connector and printed circuit board completely mounted on the support structure according to either embodiment of the invention.

### DETAILED DESCRIPTION OF THE PREFERRED EMBODIMENTS

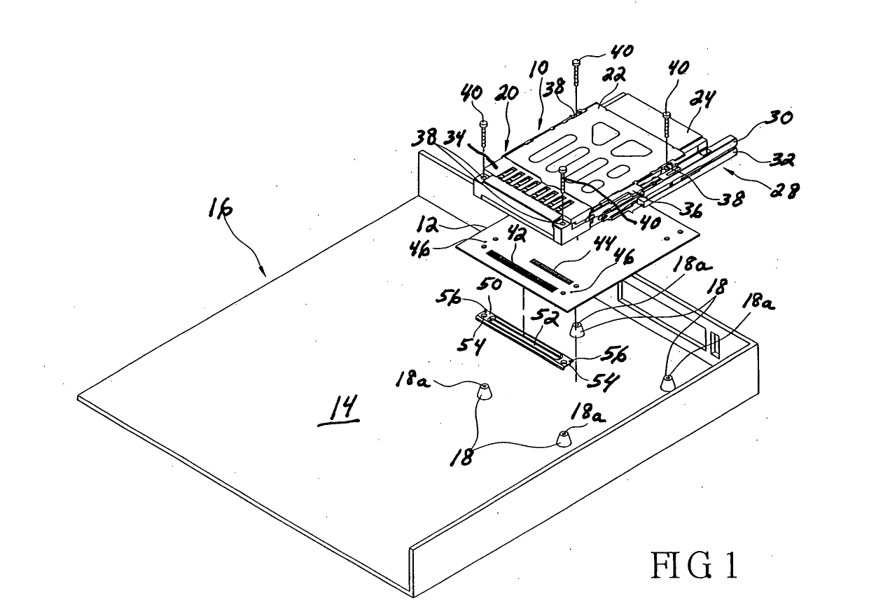

Referring to the drawings in greater detail, and first to FIG. 1, the system of the invention includes a memory card connector, generally designated 10, mountable on top of a printed circuit board 12 in an elevated position above a support plate 14 of a support structure, generally designated 16. The support structure may be a chassis of a wide range of electrical appliances, such as a word processor, personal computer, personal data assistant or the like. The subassembly of connector 10 and printed circuit board 12 are mounted on top of a plurality of pillars 18 which project upwardly from support plate 14 of support structure 16. The pillars have fastening holes 12a.

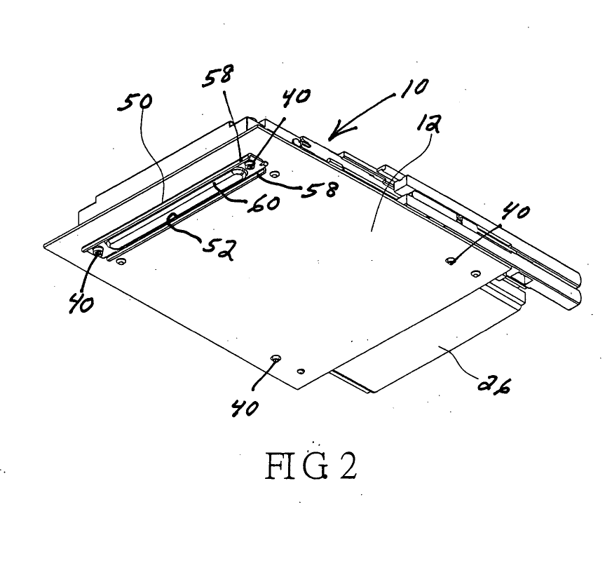

Memory card connector 10 includes an insulating or dielectric housing 20 which may be molded of plastic material. A metal shell or shield 22 is mounted to and substantially covers the housing. The connector is of a configuration which receives two different types of memory cards 24 (FIG. 1) and 26 (FIG. 2). An ejection mechanism, generally designated 28, is mounted at one side of the housing and includes a pair of ejecting arms 30 and 32 for individually ejecting memory cards 24 and 26, respectively. The housing has a rear terminal-mounting section 34 and a pair of side wall sections 36 which project forwardly from opposite ends of the rear section and between which the memory cards are inserted. The housing has four through holes 38 for receiving four fasteners 40 therethrough. In the illustrated embodiment, the fasteners are screws which are inserted through holes 38 in the housing and into fastening holes 12a in pillars 18.

Printed circuit board 12 includes a first, longer linear array of circuit traces or contact pads 42 engaging a corresponding linear array of tail portions of a plurality of terminals mounted on rear section 34 of the housing for engaging appropriate contacts of memory card connector 24. The circuit board includes a second, shorter linear array of circuit traces or contact pads 44 for engaging a corresponding linear array of tail portions of a plurality of terminals mounted on rear section 34 of the housing for engaging appropriate contacts of memory card 26. A plurality of through holes 46 are formed through the printed circuit board generally at opposite ends of the linear arrays of contact pads 42/44.

As stated in the “Background”, above, there is a tendency for the contact pads on the printed circuit board to become separated from or at least damaged in relation to the tail portions of the terminals mounted on memory card connector 10. This is true whether the contacts pads engage the tail portions by a reflow soldering process or by a pressure surface engagement. In addition, this problem is magnified when the subassembly of connector 10 and circuit board 12 are mounted on top of pillars 18 of support structure 16. The circuit board has a tendency to warp or bend downwardly between the pillars.

In order to solve the problems discussed immediately above and in the Background herein, the invention contemplates the provision of support means beneath the printed circuit board between the pair of pillars spanning the circuit pads on the printed circuit board, to prevent the board from bending or warping between the pillars. FIGS. 1 and 2 show a first embodiment of the invention wherein the support means is provided by an elongated support bracket 50 which is fabricated of rigid material whether that be molded plastic, stamped and formed metal or other appropriately fabricated metal. Bracket 50 includes an elongated slot 52 generally centrally thereof. A hole 54 and an upstanding pin 56 are formed at each opposite end of the bracket. As seen in FIG. 2, a stiffening flange 58 runs entirely along the length of each opposite side of the bracket. Elongated slot 52 allows for the formation of an additional stiffening flange 60 surrounding the slot.

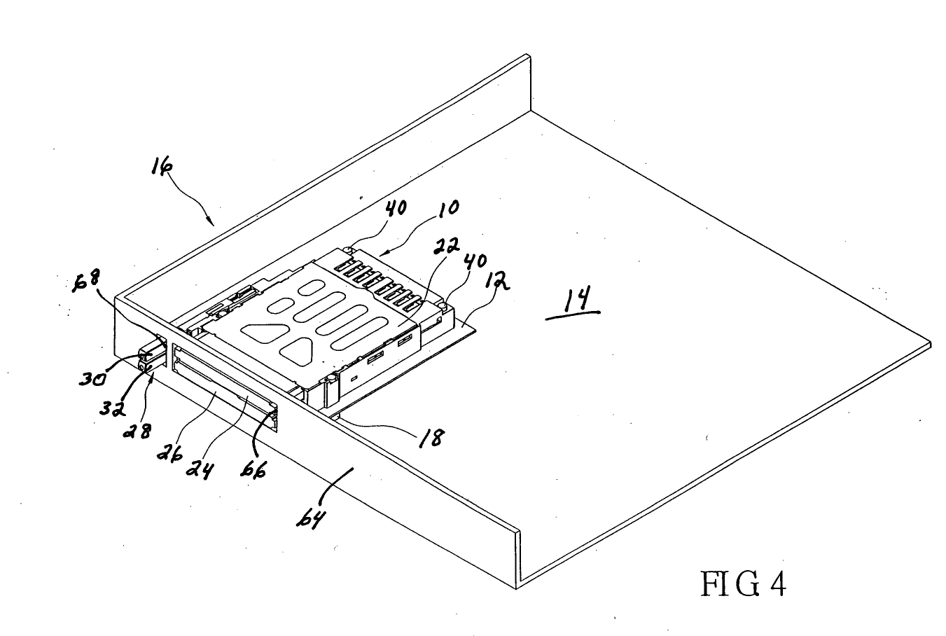

FIG. 2 shows a subassembly of memory card connector 10 mounted on top of printed circuit board 12, with support bracket 50 positioned beneath the board in alignment with the linear arrays of contact pads 42/44 (on top of the board). The components can be held in this partially assembled position by inserting screws 40 at least partially through holes 38 (FIG. 1) in connector housing 20, through one of the holes 46 in the printed circuit board and through holes 54 in support bracket 50. Upstanding pins 56 (FIG. 1) are inserted into two of the holes 46 in the board as a means to properly locate the support bracket beneath the circuit board and align the respective holes. The subassembly of FIG. 2 then is positioned on top of pillars 18 of support structure 16 as seen in FIG. 4, and the screws are tightened into the fastening holes 12a of the pillars to secure the entire assembly to the support structure. When completely assembled, support bracket 50 prevents the circuit board from bending or warping beneath contacts pads 42 and 44.

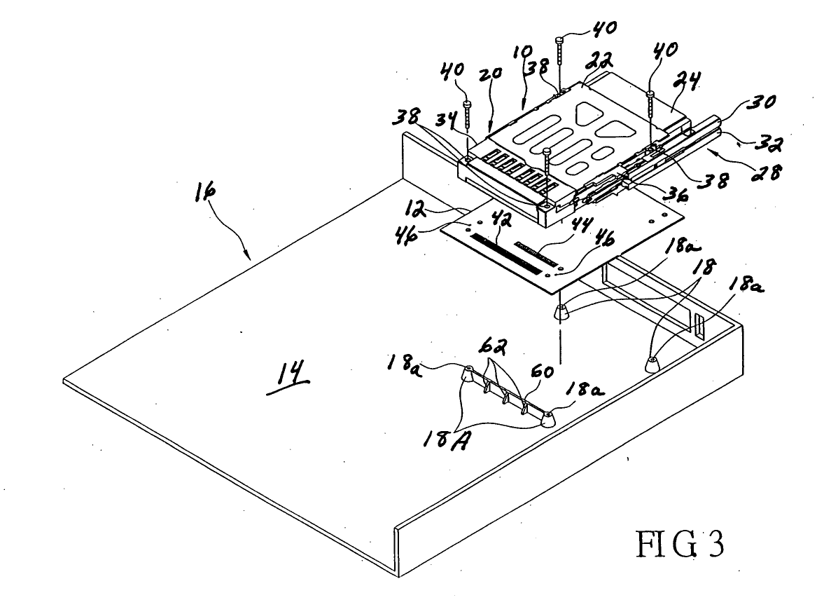

FIG. 3 shows a second embodiment of the invention and like reference numerals have been applied in FIG. 3 corresponding to the components described above in relation to the first embodiment of FIGS. 1 and 2. The descriptions of those common components will not be repeated.

Generally, the embodiment of FIG. 3 again includes support means beneath printed circuit board 12 between a pair of pillars 12a to prevent the board from bending or warping between the pillars. Specifically, the support means of the second embodiment comprises an elongated support rib 60 which extends between the pair of pillars 18A above support plate 14 of support structure 16. A plurality of stiffening gussets 62 are provided on one or both sides of the elongated support rib 60. The invention contemplates that support rib 60, gussets 62 and pillars 18A be a unitary structure which could be molded of plastic material or cast of metal material, for instance. In fact, the unitary structure could be fabricated integral with support plate 14 of support structure 16. In any event, support rib 60 prevents the printed circuit board from bending or warping between pillars 18A, and gussets 62 reinforced and stiffen support rib 60.

FIG. 4 shows memory card connector 10 mounted on top of printed circuit board 12 and this subassembly is mounted on top of pillars 18 (18A) which project upwardly from support plate 14 of support structure 16. Either embodiment of FIGS. 1 and 2 or FIG. 3 is so mounted. Support structure 16 can be a chassis of an electrical appliance which includes a side wall 64 having an elongated opening 66 and a smaller, vertically oriented opening 68. Either one or both of memory cards 24 and/or 26 are inserted through elongated opening 66 into memory card connector 10. Ejecting arms 30 and 32 of ejection mechanism 28 project through opening 68 for manual manipulation by an operator. This example shows why the memory card and circuit board are mounted in an elevated position above support plate 14. It would be difficult to mount the subassembly immediately on top of the support plate, because openings 66 and 68 would have to be completely at the bottom of wall 64. This not only would be aesthetically displeasing, but it would weaken the wall. Of course, there are many other reasons why a memory card connector and its printed circuit board might be mounted in an elevated position in an entire electronic system of an electrical appliance.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A system for mounting a memory card connector on top of a printed circuit board in an elevated position on top of at least a pair of pillars projecting upwardly from a support structure, comprising:
a memory card connector mountable on top of an appropriate printed circuit board;
fastening means extending from the connector through the printed circuit board into fastening engagement with the support structure to hold the connector and board on top of said pillars; and
support means beneath the printed circuit board between the pair of pillars to prevent the board from bending or warping between the pillars.

2. The system of claim 1 wherein said support means is a separate rigid support bracket mounted to the underside of the printed circuit board.

3. The system of claim 2 wherein said support bracket is elongated and extends between the pair of pillars.

4. The system of claim 3 wherein said fastening means include a pair of fasteners extending through the connector, through the printed circuit board through the elongated support bracket and into the pair of pillars.

5. The system of claim 3 wherein said printed circuit board includes a linear array of contact pads engageable by a linear array of tail portions of a plurality of terminals on the memory card connector, the linear array of contact pads extending generally between the pair of pillars, with the elongated support bracket disposed beneath the circuit board in position to support the contact pads against the tail portions of the terminals.

6. The system of claim 1 wherein said support means comprises an elongated support rib extending between the pair of pillars above the support structure.

7. The system of claim 6 wherein said elongated support rib is integral with the pair of pillars.

8. The system of claim 7 wherein said fastening means include a pair of fasteners extending through the connector, through the printed circuit board and into the pair of pillars.

9. The system of claim 6 wherein said printed circuit board includes a linear array of contact pads engageable by the tail portions of a plurality of terminals on the memory card connector, the linear array of contact pads extending generally between the pair of pillars, with the elongated support rib disposed beneath the circuit board in position to support the contact pads against the tail portions of the terminals.

10. The system of claim 1 wherein said fastening means include a pair of fasteners extending through the connector, through the printed circuit board and into the pair of pillars.

11. A memory card connector for mounting on a printed circuit board, comprising:
an insulating housing having a rear terminal-mounting section and at least one longitudinal side wall section extending forwardly from one end of the rear section and combining therewith to define a card-receiving space for receiving at least one memory card;
a support bracket positionable beneath the printed circuit board to prevent the board from bending or warping, the support bracket being positioned beneath an array of contact pads on a top side of the printed circuit board engageable with appropriate terminals mounted on the housing; and
fastening means extending from the housing through the printed circuit board and into the support bracket beneath the board.

12. The system of claim 11 wherein said circuit board includes a linear array of contact pads engageable by appropriate terminals on the rear terminal-mounting section of the housing, the support bracket being elongated and being disposed beneath the linear array of contact pads.

13. A system for mounting a memory card connector on top of a printed circuit board in an elevated position on top of at least a pair of pillars projecting upwardly from a support structure, comprising:
an insulating housing having a rear terminal-mounting section and at least one longitudinal side wall section extending forwardly from one end of the rear section and combining therewith to define a card-receiving space for receiving at least one memory card;
an elongated support rib extending between the pair of pillars above the support structure; and
a pair of fasteners extending through the housing, through the printed circuit board and into the pair of pillars.

14. The system of claim 13 wherein said elongated support rib is integral with the pair of pillars.

15. The system of claim 13 wherein said printed circuit board includes a linear array of contact pads engageable by the tail portions of a plurality of terminals on the memory card connector, the linear array of contact pads extending generally between the pair of pillars, with the elongated support rib disposed beneath the circuit board in position to support the contact pads against the tail portions of the terminals.
